(19) United States
(12) Patent Application Publication
(10) Pub. No.: US 2025/0028169 A1
(43) Pub. Date: Jan. 23, 2025

(54) LAMINATED PANE WITH AN ELECTRICALLY CONDUCTIVE COATING AND LOCAL ANTI-REFLECTION COATING

(71) Applicant: SAINT-GOBAIN GLASS FRANCE, COURBEVOIE (FR)

(72) Inventors: Jan HAGEN, HERZOGENRATH (DE); Klaus FISCHER, HERZOGENRATH (DE); Roberto ZIMMERMANN, HERZOGENRATH (DE)

(21) Appl. No.: 18/713,554

(22) PCT Filed: Nov. 11, 2022
(86) PCT No.: PCT/EP2022/081617

§ 371 Date: May 24, 2024

(30) Foreign Application Priority Data
Nov. 30, 2021 (EP) 21211313.8

(51) Int. Cl. G02B 27/00; G02B 1/11

(52) U.S. Cl. CPC G02B 27/0006; G02B 1/11

(57) ABSTRACT

A laminated pane includes an outer pane and an inner pane, which are connected to one another via a thermoplastic intermediate layer, an electrically conductive coating between the outer pane and the inner pane, an anti-reflection coating only in a partial region of the laminated pane which is provided for a camera window, wherein the anti-reflection coating is arranged on the surface of the inner pane facing away from the intermediate layer, and the electrically conductive coating is also arranged in the partial region.

The invention relates to a laminated pane with an electrically conductive coating and an anti-reflection coating in a defined region, a camera arrangement with such a laminated pane, and the use of the laminated pane.

Laminated panes with electrically conductive coatings are well known in the vehicle sector, for example as a windshield with an IR-reflecting and/or heatable, transparent coating. The coating typically comprises a plurality of silver layers which are applied alternatingly with dielectric layers, which ensures on the one hand high electrical conductivity and, on the other hand, sufficient transmission in the visible spectral range. Silver-containing transparent coatings are known, for example, from WO 03/024155, US 2007/0082219 A1, US 2007/0020465 A1, WO 2013/104438 or WO 2013/104439.

Vehicles, aircraft, helicopters, and ships are increasingly equipped with various sensors or camera systems. Examples are camera systems, such as video cameras, night vision cameras, residual light amplifiers, laser rangefinders (e.g., LIDAR systems) or passive infrared detectors. Vehicle identification systems are also increasingly used, for example, for toll detection.

Camera systems can use light in the ultraviolet (UV), visible (VIS) and infrared wavelength range (IR). Thus, even in poor weather conditions, such as darkness and fog, objects, vehicles, and persons can be precisely detected. Cameras used for driver assistance systems or for autonomous driving thus offer the possibility of detecting dangerous situations and obstacles in good time even in road traffic. In this case, the camera is arranged on the interior side, i.e., in the passenger compartment, behind the windshield and is directed forward so that it looks through the windshield. However, the operability of such a camera can be impaired by an electrically conductive coating. The panes are therefore usually decoated locally and form a communication window for sensors and camera systems. Such panes are known, for example, from WO 2011/069901 A1 or WO 2015/071673 A1. However, such a local decoating of the laminated pane is associated with disadvantages. The positive properties of the electrically conductive coating, such as a reduction of the heat radiation input into the vehicle interior and optionally an ability to heat the camera window, are lost in the camera window. However, in particular in the region of a camera and a sensor, a ability to be heated is valuable, since at cold temperatures, fogging or icing of the camera region can be prevented.

US2007/0020465A1 discloses a laminated pane with an electrically conductive heating layer arranged between the inner and outer pane. An anti-reflection coating is applied over at least the entire surface of the inner pane facing away from the heating layer. The anti-reflection coating can also be applied to more than one surface of the laminated pane.

WO 2019/179682A1, WO2019/179683A1 and WO2019/206493A1 each disclose a laminated pane for a projection arrangement. The laminated pane is provided in particular for use in a head-up display. In order to avoid ghost images in a projection arrangement equipped with the laminated pane, an anti-reflection coating is applied over the entire interior-side surface of the inner pane.

As already mentioned, different camera systems use different wavelength ranges. Many cameras require a relatively high transmittance in the red spectral range. This requirement is easily achieved for an uncoated pane. Electrically conductive, in particular silver-based, coatings, however, decrease the transmittance in the red spectral range to a critical extent. The ratio of the transmittance in the spectral range of 600 nm to 700 nm to the transmittance in the spectral range of 440 nm to 700 nm should be at least 0.70, for example, for cameras operating in the red spectral range. In DE202019102388U1, an optical superlattice is applied in the region of the camera window in order to increase this ratio, which optical superlattice is arranged between the two panes of the laminated pane. An optical superlattice consists of many thin layers with an alternating refractive index, which repeat periodically. Due to the plurality of layers, these superlattices are comparatively expensive and, due to the low layer thickness of individual layers, are sometimes sensitive to weather and mechanical damage. The superlattice is therefore arranged between two panes, where it is well protected from external influences.

The object of the present invention is to provide a laminated pane with an electrically conductive coating which has the transmittance required for a specific camera, without the electrically conductive coating being removed in the region in question. The laminated pane should also be cost-effective and easy to produce.

The object of the present invention is achieved according to the invention by a laminated pane according to claim 1. Preferred embodiments are apparent from the dependent claims.

The invention is based on providing a partial region of the laminated pane, which is provided for a camera window, with an anti-reflection coating. Anti-reflection coatings are generally used to suppress the reflection on surfaces and to increase transmittance. Using the anti-reflection coating, the transmittance properties of the laminated pane with an electrically conductive coating are adapted such that a camera directed onto the partial region of the laminated pane with the anti-reflection coating can perceive signals from the other side of the pane without interference. At the same time, the electrically conductive coating can be retained in the partial region, so that the positive properties of the electrically conductive coating are also present in the partial region.

The laminated pane according to the invention comprises an outer pane and an inner pane which are connected to one another via a thermoplastic intermediate layer. The laminated pane is provided for separating the interior from the external environment in a window opening, in particular the window opening of a vehicle. In the sense of the invention, the term inner pane refers to the pane of the laminated pane facing the interior (in particular the vehicle interior). Outer pane means the pane facing the external environment.

The outer pane and the inner pane each have an outer-side and an interior-side surface and a peripheral side edge extending between them. In the context of the invention, the outer surface means the main surface which is provided to face the external environment when installed. In the context of the invention, the interior-side surface means the main surface which is intended to face the interior space when installed. The interior-side surface of the outer pane and the outer surface of the inner pane face one another and are connected to one another by the thermoplastic intermediate layer.

The thermoplastic intermediate layer of the laminated pane is formed by at least one layer of thermoplastic material. The intermediate layer can consist of this one layer of thermoplastic material and can be formed, for example, from a single polymer film or casting resin layer. However, the intermediate layer can also comprise a plurality of layers of thermoplastic material and can be formed, for example, from a plurality of polymer films arranged flat on top of one another.

The laminated pane also has an electrically conductive coating which is arranged between the outer pane and the inner pane, so that it is protected from moisture, weather, and mechanical damage. The electrically conductive coating is preferably applied to the outer-side surface of the inner pane facing the intermediate layer or to the interior-side surface of the outer pane facing the intermediate layer. Preferably, the coating can alternatively be arranged within the intermediate layer. For this purpose, the coating is typically applied to a carrier film, for example made of polyethylene terephthalate (PET), with a thickness of about 50 μm which is arranged between two layers of thermoplastic material, for example between two polymer films.

Preferably, at least 80% of the pane surface is provided with the electrically conductive coating. In particular, the laminated pane is provided with the electrically conductive coating over the entire surface with the exception of a peripheral edge region and optionally local regions, which are intended to ensure the transmission of electromagnetic radiation through the laminated pane as a communication window or sensor window, and therefore are not provided with the coating. The peripheral uncoated edge region has, for example, a width of up to 20 cm. It prevents direct contact of the electrically conductive coating with the surrounding atmosphere, so that the coating in the interior of the laminated pane is protected against corrosion and damage.

In a partial region of the laminated pane, which is provided for a camera window, an anti-reflection coating is arranged which is arranged on the surface of the inner pane facing away from the intermediate layer. The electrically conductive coating is likewise arranged in the partial region. That is to say that the electrically conductive coating has not been removed in the partial region of the laminated pane which is provided for a camera window. The camera window is provided to ensure the view for a camera or other optical sensors. The camera window is the region of the laminated pane onto which the optical beam path of a camera or another optical sensor is to be directed.

The anti-reflection coating increases the transmittance through the pane, so that the camera can detect more radiation in the region of interest in each case. The anti-reflection coating can be adapted to the respective camera to be used.

The anti-reflection coating can in principle be designed in different ways. For example, anti-reflection coatings made of porous silicon dioxide layers or those which are generated by etching skeletonization of a glass surface are known.

In a preferred embodiment, the anti-reflection coating is formed from alternatingly arranged dielectric layers with different refractive indices which, due to interference effects, lead to a reduction of the reflection at the coated surface and thus to an increase in the transmittance. Such anti-reflection coatings are very effective and can be optimized well for the requirements in individual cases by selecting the materials and layer thicknesses of the individual layers.

The anti-reflection coating is preferably arranged directly on the inner pane. This means that it is not applied via a carrier film, for example.

In a preferred embodiment, in the partial region with the anti-reflection coating, the laminated pane has a ratio of the transmittance in the red spectral range (600 nm to 700 nm) to the transmittance in the entire visible spectral range (440 nm to 700 nm) of at least 0.70. This is advantageous for the use of the laminated pane in conjunction with a camera which is directed onto the partial region with the anti-reflection coating. In particular, the red signals occurring in road traffic can then be perceived better by the camera. The angle α of the camera alignment (horizontal h) to the surface normal f onto the laminated pane is preferably about 55° to 70°. This corresponds to an angle β between the camera alignment (horizontal h) and the surface of the laminated pane of approximately 20° to 35°. Using the anti-reflection coating, the transmittance properties of the laminated pane can be influenced in order to adjust the ratio of the transmittance in the spectral range of 600 nm to 700 nm to the transmittance in the spectral range of 440 nm to 700 nm to a desired value, preferably at least 0.75, particularly preferably at least 0.80. The values mentioned (transmittance ratio values) are integral values, i.e., averaged values for the corresponding wavelength ranges, which are not calculated with the eye sensitivity curve and a light type. Here, the values are determined at an angle of at least 55°. The aforementioned ratio is referred to below as the transmittance ratio. The desired transmittance ratio can in particular be achieved in that the transmittance in the red spectral range, for example from 600 nm to 700 nm, is increased by the anti-reflection coating. Alternatively, the anti-reflection coating preferably lowers the transmittance in the blue spectral range, for example from 440 nm to 480 nm. The advantage of anti-reflection coatings is the possibility of influencing the wavelength, the bandwidth, and the level of the reflection via the selection and layer thickness of the individual components of the anti-reflection coating. The properties can thus also be adapted to the camera used, the specification of which is individually different.

In a preferred embodiment, the anti-reflection coating is formed from alternatingly arranged dielectric layers with different refractive indices. The anti-reflection coating here consists of at least two dielectric layers, wherein layers having a high refractive index (preferably greater than or equal to 2.0 at a wavelength of 550 nm) and layers having a low refractive index (preferably less than or equal to 1.8 at a wavelength of 550 nm) are arranged alternatingly one above the other. Interference effects lead to a reduction of the reflection at the coated surface and thus to an increase in the transmittance.

The anti-reflection coating preferably consists of two to eight alternatingly arranged dielectric layers, particularly preferably of two to six alternatingly arranged dielectric layers. This comparatively small number of dielectric layers is particularly cost-effective to implement and is simpler to produce compared to, for example, an optical superlattice. Particularly preferably, the anti-reflection coating consists of only two to four dielectric layers. Very particularly preferably, the anti-reflection coating consists of exactly two dielectric layers.

Preferably, a layer with a high refractive index is first arranged in the anti-reflection coating starting from the inner pane and preferably in direct contact with the inner pane, above that a layer with a low refractive index, above that possibly a further layer with a high refractive index and above that possibly a further layer with a low refractive index. If necessary, the layer sequence can be continued accordingly.

Preferably, a titanium oxide-based layer is first arranged in the anti-reflection coating starting from the inner pane, followed by a silicon oxide-based layer. Particularly preferably, no further layers are contained in the anti-reflective coating. This can be produced particularly easily.

Alternatively, a silicon nitride-based layer is first arranged in the anti-reflection coating starting from the inner pane, and above it a silicon oxide-based layer. Particularly preferably, no further layers are contained in the anti-reflective coating. This can be produced particularly easily and can be realized cost-effectively due to the high deposition rates of the components.

In a preferred embodiment, in the anti-reflective coating, the dielectric layer or the dielectric layers with a low refractive index are embodied on the basis of silicon oxide or aluminum oxide.

The dielectric layer or the dielectric layers with a high refractive index are preferably embodied on the basis of silicon nitride, silicon carbide, titanium oxide, a silicon-metal mixed nitride such as silicon zirconium nitride or silicon hafnium nitride. These materials are resistant to corrosion and mechanically stable, so that an arrangement on the exposed surface of the inner pane is possible without problems. The number of layers and the layer thicknesses are selected according to the requirements in the individual case, which can be determined by simulations.

If a first layer is arranged above a second layer, this means, in the sense of the invention, that the first layer is arranged further away from the substrate on which the coating is applied than the second layer. If a first layer is arranged below a second layer, this means, in the sense of the invention, that the second layer is arranged further away from the substrate than the first layer. If a first layer is arranged above or below a second layer, this does not necessarily mean, in the sense of the invention, that the first and the second layer are in direct contact with one another. One or more additional layers can be arranged between the first and the second layer, provided that this is not explicitly ruled out. If a layer based on a material is formed, the layer consists of a majority of this material in addition to any impurities or dopants.

In a preferred embodiment, in the anti-reflection coating, the dielectric layers each have a geometric layer thickness between 30 nm and 500 nm, preferably between 50 nm and 300 nm, particularly preferably between 70 nm and 200 nm. The thickness of the layers is selected such that the layers are sufficiently stable to be arranged on the exposed side of the inner pane and that at the same time no high material costs arise.

In the context of the present invention, refractive indices are in all cases specified in relation to a wavelength of 550 nm. The refractive index can be determined, for example, by ellipsometry. The refractive index can be determined, for example, by ellipsometry at a wavelength of 550 nm. Ellipsometers are commercially available—for example, from the Sentech company. The refractive index of an upper or lower dielectric layer is preferably determined by first depositing it as a single layer on a substrate and subsequently measuring the refractive index by means of ellipsometry. To determine the refractive index of an upper or lower dielectric layer sequence, the layers of the layer sequence are each deposited alone as individual layers on a substrate and then the refractive index is determined by means of ellipsometry. The optical thickness is the product of the geometric thickness and the refractive index (at 550 nm). The optical thickness of a layer sequence is calculated as the sum of the optical thicknesses of the individual layers.

The anti-reflection coating is preferably applied only to a partial region of the laminated pane through which the beam path of the camera passes. This means that the anti-reflection coating does not extend over the entire surface of the inner pane facing away from the intermediate layer, but only over a partial region of this surface. The partial region with the anti-reflection coating is preferably located outside the central viewing region of the laminated pane, so that an increase in the transmittance in the red spectral range has no negative effects for the occupants of the vehicle, in particular with regard to the total transmittance and a possible color tinting. The partial region with the anti-reflection coating preferably covers only at most 70% of the surface of the pane, particularly preferably only at most 40% of the surface of the pane, very particularly preferably only at most 30% of the surface of the pane, very particularly only at most 20% of the surface of the pane. The partial region with the anti-reflection coating can, for example, extend in the upper region of the pane in the form of a continuous surface region from the left to the right side of the laminated pane. Sensors or cameras are often arranged in this region. By applying the anti-reflection regions to smaller partial regions, material and processing costs can be saved.

The partial region with the anti-reflection coating extends, for example, preferably over an area of 200 mm² to 10 000 mm², particularly preferably of 1000 mm² to 8000 mm². In a windshield for a vehicle, the camera window is preferably arranged in the vicinity of the roof edge. This region is generally no longer part of the central viewing region.

In a further preferred embodiment, the laminated pane comprises more than one partial region with the anti-reflection coating, preferably two or three partial regions with the anti-reflection coating. This is particularly advantageous if various cameras are used which are arranged at different positions.

The laminated pane is preferably a front screen of a water, land, or air vehicle, particularly preferably a vehicle windshield (in particular the windshield of a motor vehicle, for example a passenger vehicle or truck).

The electrically conductive coating is in particular a transparent, electrically conductive coating. The electrically conductive coating is preferably an IR-reflective solar control coating or a heatable coating that is electrically contacted and heats up when current flows through. A transparent coating is understood to mean a coating which has an average total transmittance in the visible spectral range of at least 70%, preferably at least 80%, which therefore does not significantly restrict the view through the pane.

The electrically conductive coating is preferably a layer stack or a layer sequence comprising one or more electrically conductive, in particular metal-containing layers, wherein each electrically conductive layer is arranged in each case between two dielectric layers or layer sequence. The coating is therefore a thin-film stack with n electrically conductive layers and (n+1) dielectric layers or layer sequences, wherein n is a natural number, and wherein a conductive layer and a dielectric layer or layer sequence always alternatingly follows a lower dielectric layer or layer sequence. Such coatings are known as solar control coatings and heatable coatings, wherein the electrically conductive layers are typically formed on the basis of silver. The conductive coating preferably comprises at least two electrically conductive layers, particularly preferably at least three electrically conductive layers, very particularly preferably at least four electrically conductive layers. The higher the number of conductive layers, the better the coating can be optimized with regard to a desired transmittance, coloring, or a desired sheet resistance.

The electrical conductivity of the coating is brought about by the functional, electrically conductive layers. By dividing the entire conductive material into several separate layers, each of these can be made thinner, thereby increasing the transparency of the coating. Each electrically conductive layer preferably contains at least one metal or a metal alloy, for example silver, aluminum, copper or gold, and is particularly preferably formed on the basis of the metal or the metal alloy, i.e. consists essentially of the metal or the metal alloy apart from any dopants or impurities. The electrically conductive layers are preferably formed on the basis of silver. In an advantageous design, the electrically conductive layer contains at least 90 wt. % silver, particularly preferably at least 99 wt. % silver, particularly preferably at least 99.9 wt % silver.

The electrically conductive layers preferably each have a layer thickness from 3 nm to 20 nm, particularly preferably from 5 nm to 15 nm. The total thickness of all electrically conductive layers of the electrically conductive coating is preferably from 20 nm to 70 nm, particularly preferably from 30 nm to 65 nm. If the total thickness is too high, the transmittance through the pane can be greatly impaired.

In a preferred embodiment, dielectric layers or layer sequences are arranged between the electrically conductive layers and below the lowermost conductive layer and above the uppermost conductive layer. Each dielectric layer or layer sequence preferably has at least one anti-reflective layer. The anti-reflective layers reduce the reflection of visible light and therefore increase the transparency of the coated pane. The anti-reflective layers contain, for example, silicon nitride (SiN), silicon/metal mixed nitrides such as silicon/zirconium nitride (SiZrN), aluminum nitride (AlN) or tin oxide (SnO). The anti-reflective layers can moreover have dopants.

The anti-reflective layers can in turn be subdivided into at least two sub-layers, in particular into an optically low-refractive layer having a refractive index of less than 2.1, and an optically highly refractive layer having a refractive index greater than or equal to 2.1. Preferably, at least one anti-reflective layer arranged between two electrically conductive layers is subdivided in this manner, particularly preferably two anti-reflective layers arranged between two electrically conductive layers. The subdivision of the anti-reflective layer results in a lower sheet resistance of the electrically conductive coating with simultaneously high transmission and high color neutrality. The order of the two partial layers can in principle be selected as desired, wherein the optically highly refractive layer is preferably arranged above the dielectric layer, which is particularly advantageous with regard to sheet resistance. The thickness of the optically highly refractive layer is preferably from 10% to 99%, particularly preferably from 25% to 75% of the total thickness of the anti-reflective layer.

In the electrically conductive coating, the optically highly refractive layer having a refractive index greater than or equal to 2.1 contains, for example, a silicon/metal mixed nitride, for example mixed silicon/zirconium nitride (SiZrN). This is particularly advantageous with regard to the sheet resistance of the electrically conductive coating. The mixed silicon/zirconium nitride preferably has dopants. The layer of an optically highly refractive material can contain, for example, an aluminum-doped mixed silicon/zirconium nitride.

In the electrically conductive coating, the low-refractive dielectric layer with a refractive index of less than 2.1 preferably has a refractive index n between 1.6 and 2.1, particularly preferably between 1.9 and 2.1. The low-refractive dielectric layer preferably contains at least one oxide and/or a nitride, particularly preferably silicon nitride.

In an advantageous embodiment, one or more dielectric layer sequences in the electrically conductive layer have a first adaptation layer, preferably each dielectric layer sequence which is arranged below an electrically conductive layer. The first adaptation layer is preferably arranged above the anti-reflective layer.

In an advantageous embodiment, one or more dielectric layer sequences have a second adaptation layer, preferably each dielectric layer sequence arranged above an electrically conductive layer. The second adaptation layer is preferably arranged below the anti-reflective layer.

The first and second adaptation layers cause an improvement of the sheet resistance of the coating. The first adaptation layer and/or the second adaptation layer preferably contain zinc oxide ZnO_{1-δ} with 0≤δ≤0.01. The first adaptation layer and/or the second adaptation layer also preferably contain dopants. The first adaptation layer and/or the second adaptation layer can contain aluminum-doped zinc oxide (ZnO:AI), for example. The zinc oxide is preferably deposited sub-stoichiometrically with respect to the oxygen in order to avoid a reaction of excess oxygen with the silver-containing layer.

In an advantageous embodiment, one or more dielectric layer sequences in the electrically conductive layer have a smoothing layer, preferably each dielectric layer sequence, which is arranged between two electrically conductive layers. The smoothing layer is arranged below one of the first adaptation layers, preferably between the anti-reflective layer and the first adaptation layer. The smoothing layer is particularly preferably in direct contact with the first adaptation layer. The smoothing layer yields an optimization, in particular smoothing of the surface for an electrically conductive layer subsequently applied above. An electrically conductive layer deposited on a smoother surface has a higher transmittance with a simultaneously lower sheet resistance. The smoothing layer preferably has a refractive index of less than 2.2.

The smoothing layer preferably contains at least one non-crystalline oxide. The oxide may be amorphous or partially amorphous (and therefore partially crystalline), but is not completely crystalline. The non-crystalline smoothing layer has a low roughness and therefore forms an advantageously smooth surface for the layers to be applied above the smoothing layer. The non-crystalline smoothing layer also effects an improved surface structure of the layer, which is preferably the first adaptation layer, deposited directly above the smoothing layer. The smoothing layer can contain, for example, at least one oxide of one or more of the elements tin, silicon, titanium, zirconium, hafnium, zinc, gallium and indium. The smoothing layer particularly preferably contains a non-crystalline mixed oxide. The smoothing layer particularly preferably contains a tin/zinc mixed oxide (ZnSnO). The mixed oxide can have dopants. The smoothing layer can contain, for example, an antimony-doped tin/zinc mixed oxide. The mixed oxide preferably has a sub-stoichiometric oxygen content.

In an advantageous embodiment, the electrically conductive coating comprises one or more blocker layers. At least one, particularly preferably each electrically conductive layer, is preferably associated with at least one blocker layer. The blocker layer is in direct contact with the electrically conductive layer and is arranged directly above or directly below the electrically conductive layer. No additional layer is therefore arranged between the electrically conductive layer and the blocker layer. A blocker layer can also be arranged directly above and directly below a conductive layer. The blocker layer preferably contains niobium, titanium, nickel, chromium and/or alloys thereof, particularly preferably nickel-chromium alloys. A blocker layer directly below the electrically conductive layer serves in particular for stabilizing the electrically conductive layer during a temperature treatment and improves the optical quality of the electrically conductive coating. A blocker layer directly above the electrically conductive layer prevents contact of the sensitive electrically conductive layer with the oxidizing reactive atmosphere during the deposition of the following layer by reactive cathode sputtering, for example of the second adaptation layer.

The outer pane and the inner pane are preferably made of glass, in particular of soda-lime glass, which is customary for window panes. In principle, however, the panes can also be produced from other types of glass (for example borosilicate glass, quartz glass, aluminosilicate glass) or transparent plastics (for example polymethyl methacrylate or polycarbonate). The thickness of the outer pane and the inner pane can vary widely. Preferably, panes having a thickness in the range from 0.8 mm to 5 mm, preferably from 1.4 mm to 2.5 mm, are used, for example those with the standard thicknesses of 1.6 mm or 2.1 mm.

The outer pane, the inner pane and the thermoplastic intermediate layer can be clear and colorless, but also tinted or colored. The total transmittance through the composite glass in the viewing region is greater than 70% in a preferred embodiment (light type A). The term total transmittance relates to the method defined by ECE-R 43, Annex 3, § 9.1 for testing the light transmittance of motor vehicle panes. The total transmittance in the region of the camera window can be lower because it is usually located outside the viewing region.

Independently of each other the outer pane and the inner panes can be not prestressed, partially prestressed or prestressed. If at least one of the panes should be prestressed, this can be thermal or chemical prestressing. The laminated pane is preferably curved in one or more spatial directions, as is usual for motor vehicle panes, wherein the typical radii of curvature are in a range of approximately 10 cm to approximately 40 m. However, the laminated pane can also be flat, for example if it is provided as a pane for buses, trains or tractors.

The thermoplastic intermediate layer comprises at least one thermoplastic polymer, preferably ethylene vinyl acetate (EVA), polyvinyl butyral (PVB) or polyurethane (PU), or mixtures, or copolymers, or derivatives thereof, particularly preferably PVB. The intermediate layer is typically formed from a thermoplastic film. The thickness of the intermediate layer is preferably from 0.2 mm to 2 mm, particularly preferably from 0.3 mm to 1 mm. If a wedge-shaped intermediate layer is used, the thickness is determined at the thinnest point, typically at the lower edge of the laminated pane.

The laminated pane can be produced by methods known per se. The outer pane and the inner pane are laminated together via the intermediate layer, for example by autoclave processes, vacuum bag processes, vacuum ring processes, calendering processes, vacuum laminators, or combinations thereof. The outer pane and inner pane are usually connected under the effect of heat, vacuum and/or pressure.

The electrically conductive coating is preferably applied to the inner pane by physical vapor deposition (PVD), particularly preferably by cathode sputtering, very particularly preferably by magnetic field-assisted cathode sputtering. The anti-reflection coating can also be applied using such a method. Preferably, the anti-reflection coating is applied by means of a PVD method from the left-hand side to the right-hand side of the pane in the case of large-area coatings, such as in a continuous surface region.

The anti-reflection coating is preferably applied via an atmospheric plasma coating method (Plasmatreat company) or via wet-chemical application methods, which are known from the prior art. These methods can be carried out at atmospheric pressure and thus be flexibly integrated into or downstream of the method. These methods are also particularly suitable for applying coatings in a locally limited region. These methods can also be applied to finished laminated panes, which increases the flexibility in production.

The electrically conductive coating is applied to the panes before lamination. Instead of applying the electrically conductive coating to a pane surface, it can in principle also be provided on a carrier film which is arranged in the intermediate layer.

The anti-reflection coating is likewise preferably applied to the pane before lamination, in particular when it is applied via a PVD method. Alternatively, the anti-reflection coating is preferably applied to the pane after lamination, in particular when it is applied via an atmospheric plasma coating method.

If the laminated pane is to be curved, the outer pane and the inner pane are preferably subjected to a bending process before lamination and preferably after any coating processes. Preferably, the outer pane and the inner pane are curved together congruently (i.e., simultaneously and by the same tool) because this optimally matches the shape of the panes to one another for the subsequent lamination. Typical temperatures for glass-bending processes are, for example, 500° C. to 700° C.

The laminated pane can also be designed as a windshield for a head-up display (HUD). In this case, the laminated pane is irradiated by a projector, whereby a virtual image perceptible to the driver is generated. The intermediate layer can be wedge-shaped in order to avoid ghost images due to the multiple reflection at the glass surfaces and/or the conductive coating, which is known per se. The problem of the ghost images occurs in particular if the HUD projector uses s-polarized radiation which is efficiently reflected from the glass surfaces (angle of incidence typically close to the Brewster angle). However, an HUD projector with p-polarized radiation can also be used, wherein a significant reflection occurs only on the conductive coating. A wedge-shaped intermediate layer can then be dispensed with.

A further aspect of the present invention is a camera arrangement with a camera and a laminated pane according to the invention. In this case, the camera is directed onto the partial region with the anti-reflection coating and receives light beams which fall through the laminated pane. This means that the camera and the electrically conductive coating are arranged in the beam path of the camera. The camera is preferably fastened in the interior of the vehicle to the interior-side surface of the inner pane. The camera is directed through the laminated pane. The camera can be, for example, part of a driver assistance system or a so-called “mobile eye” camera for autonomous driving. The camera can be any optical sensor, such as, for example, a sensor for a laser-assisted distance measurement.

The invention further comprises the use of the laminated pane according to the invention as a front pane with a camera window in means of water, land, and air transportation, preferably in a motor vehicle as a windshield.

In the following, the invention is explained in more detail with the aid of a drawing and examples of embodiments. The drawing is a schematic representation and is not true to scale. The drawing does not limit the invention in any way.

### IN THE FIGURES

FIG. 1 shows a cross-section through a camera arrangement according to the invention,

FIG. 2 shows transmittance spectra of two embodiments of a laminated pane according to the invention and of a comparative example,

FIG. 3 shows transmittance spectra of two embodiment of a laminated pane according to the invention and of a comparative example, and

FIG. 4 shows a cross-section through an inner pane with an electrically conductive coating and an anti-reflection coating according to the invention.

FIG. 1 shows an embodiment of a laminated pane 10 according to the invention, which is provided as a windshield of a passenger vehicle. The laminated pane 10 is constructed from an outer pane 1 and an inner pane 2, which are connected to one another via a thermoplastic intermediate layer 3. In the installed position, the outer pane 1 faces the external environment; the inner pane 2 faces the vehicle interior. The outer pane 1 has an outer-side surface I which, in the installed position, faces the external environment, and an interior-side surface II which faces the interior in the installed position. Likewise, the inner pane 2 has an outer-side surface III which faces the external environment in the installed position, and an interior-side surface IV which faces the interior in the installed position.

The outer pane 1 and the inner pane 2 consist, for example, of soda-lime glass. The outer pane 1 has, for example, a thickness of 2.1 mm, the inner pane 2 has a thickness of 1.6 mm. The intermediate layer 3 is formed from a single layer of thermoplastic material, for example from a PVB film with a thickness of 0.76 mm (measured on the lower edge U).

The laminated pane 10 also comprises an electrically conductive coating 20 which is applied on the outer-side surface Ill of the inner pane 2 and is provided, for example, as an IR-reflective coating or as a heatable coating.

A camera 4, for example a camera from the company Mobileye for autonomous driving, is arranged on the interior side of the laminated pane 10. The camera 4 is directed substantially horizontally forward. In typical installation positions of windshields, the detection direction of the camera 4 (horizontal h) encloses an angle of 66° (α) with the surface normal f of the laminated pane 10. An anti-reflection coating 30 is applied in the beam path of the camera 4 on the interior-side surface IV of the inner pane 2. The anti-reflection coating 30 reduces the reflection at the surface IV and increases the transmittance in order to improve the detection of signals by the camera. This is done either by an increase in the overall transmittance or preferably by a selective increase in the transmittance ratio T(600 nm-700 nm)/T(440 nm-700 nm), which is particularly advantageous for the perception of red signals and, depending on the camera, preferred. The anti-reflection coating 30 acts like a band filter which reduces the transmittance in the blue spectral range and/or increases the transmittance in the red spectral range. The transmittance ratio is thereby increased, which is advantageous for the operability of the camera 4.

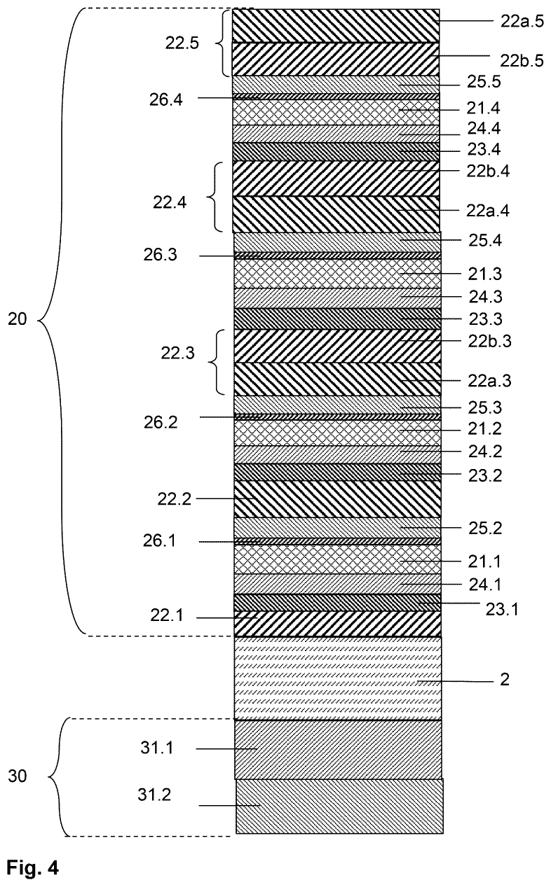

Table 1 and FIG. 4 show two exemplary structures of two laminated panes according to the invention (Examples 1 and 2) with an electrically conductive coating 20 and anti-reflection coating 30, including the materials and layer thicknesses. In FIG. 4, the thermoplastic intermediate layer and the outer pane 1 are not shown. The laminated pane with only the electrically conductive coating 20 is listed in the table column “Reference 4 Ag.” The electrically conductive coating 20 contains four electrically conductive layers 21.1, 21.2, 21.3, 21.4. Each electrically conductive layer 21 is in each case arranged between two of a total of five anti-reflective layers 22.1, 22.2, 22.3, 22.4, 22.5. The anti-reflective layers 22.5, 22.4, 22.3 are each divided into a dielectric layer 22a.5, 22a.4, 22a.3 and an optically highly refractive layer 22b.5, 22b.4, 22b.3. The electrically conductive coating 20 also contains four smoothing layers 23.1, 23.2, 23.3, 23.4, four first adaptation layers 24.1, 24.2, 24.3, 24.4, four second adaptation layers 25.2, 25.3, 25.4, 25.5 and four blocker layers 26.1, 26.2, 26.3, 26.4.

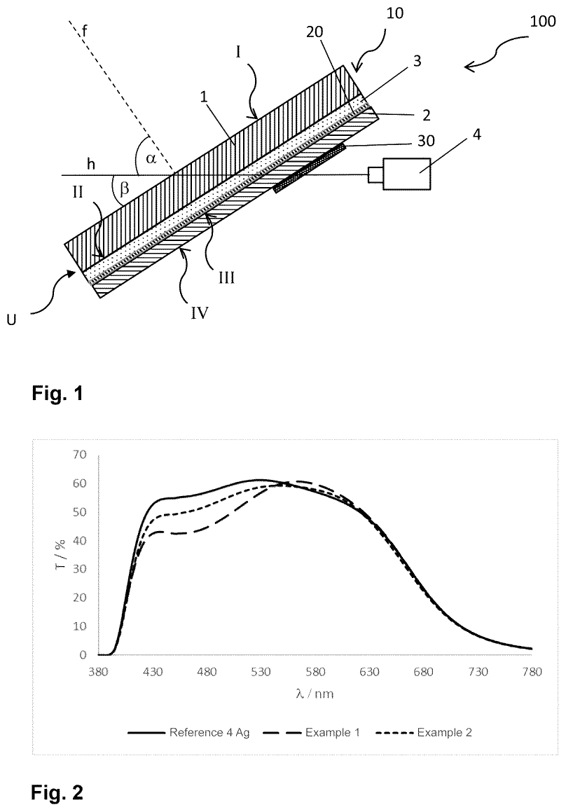

The anti-reflection coating 30 from Example 1 is constructed from dielectric layer having a high refractive index based on titanium oxide (TiO2) and layer having a low refractive index based on silicon oxide (SiO2). The two layers are arranged alternatingly, wherein the layer arranged directly on the glass is a layer with a high refractive index. FIG. 2 shows a transmittance spectrum of the laminated pane according to the invention according to Example 1 with the structure shown in Table 1 and a transmittance spectrum of the comparative example “Reference 4 Ag.” The comparative example has the structure shown in Table 1 in the column “Reference 4 Ag.” A comparison of the two transmittance spectra shows that, due to the anti-reflection coating 30, the transmittance decreases significantly in the blue spectral range and increases somewhat in the red spectral range. For the laminated pane with the anti-reflective coating according to Example 1, this leads to an increased transmittance ratio Tred/Ttot of 0.81 compared to 0.74 without an anti-reflective coating (see Table 3). This is a significantly improved transmittance ratio which was achieved with the aid of a cost-effectively applicable anti-reflection coating. Both transmittance spectra were measured under the same conditions at an angle α of 66°.

The anti-reflection coating 30 from Example 2 is constructed from a dielectric layer with a high refractive index based on silicon nitride (Si3N4) and a layer with a low refractive index based on silicon oxide (SiO2). The two layers are arranged alternatingly, wherein the layer arranged directly on the glass is a layer with a high refractive index. FIG. 2 also shows a transmittance spectrum of the laminated pane according to the invention according to Example 2 with the structure shown in Table 1. A comparison with the transmittance spectrum of the comparative example “Reference 4 Ag” shows that the transmittance in the blue spectral range decreases significantly due to the anti-reflection coating 30. For the laminated pane with the anti-reflective coating according to Example 2, this leads to an increased transmittance ratio Tred/Ttot of 0.76 in comparison to 0.74 without the anti-reflective coating (see Table 3). Both transmittance spectra were measured under the same conditions at an angle α of 66°.

Table 2 shows two exemplary structures of two laminated panes according to the invention with an electrically conductive coating 20 and an anti-reflection coating 30 (Examples 3 and 4), including the materials and layer thicknesses. The laminated pane with only the electrically conductive coating 20 with three electrically conductive layers 21.1, 21.2, 21.3 is listed in the table column “Reference 3 Ag”. Each electrically conductive layer 21 is in each case arranged between two of a total of four anti-reflective layers 22.1, 22.2, 22.3, 22.4. The anti-reflective layers 22.4, 22.3, 22.2 are each divided into a dielectric layer 22a.4, 22a.3, 22a.2 and an optically highly refractive layer 22b.4, 22b.3, 22b.2. The electrically conductive coating 20 also contains three smoothing layers 23.1, 23.2, 23.3, three first adaptation layers 24.1, 24.2, 24.3, three second adaptation layers 25.2, 25.3, 25.4 and three blocker layers 26.1, 26.2, 26.3.

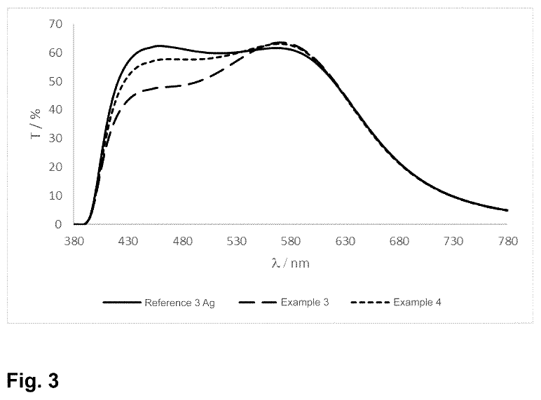

The anti-reflective coating 30 from Example 3 is constructed from a dielectric layer having a high refractive index based on titanium oxide (TiO2) and a layer having a low refractive index based on silicon oxide (SiO2). The anti-reflection coating 30 from Example 4 is constructed from a dielectric layer with a high refractive index based on silicon nitride (Si3N4) and a layer with a low refractive index based on silicon oxide (SiO2). The two layers are each arranged alternatingly, wherein the layer arranged directly on the glass is a layer with a high refractive index. FIG. 3 shows the transmittance spectrum of the laminated pane according to the invention according to Examples 3 and 4 with the structure shown in Table 2 and the transmittance spectrum of the comparative example “Reference 3 Ag.” All transmittance spectra were measured under the same conditions at an angle α of 66°.

A comparison of the transmittance spectra of Example 3 and of the comparative example “Reference 4 Ag” shows that, due to the anti-reflection coating 30, the transmittance significantly decreases in the blue spectral range and increases slightly in the red. For the laminated pane with the anti-reflective coating according to Example 3, this leads to an increased transmittance ratio Tred/Ttot of 0.76 in comparison to 0.70 without the anti-reflective coating (see Table 3). This is a significantly improved transmittance ratio which was achieved by the application of a relatively simply structured anti-reflection coating. An increased transmittance ratio Tred/Ttot of 0.71 was also achieved for Example 4.

TABLE 1
Examples 1 and 2

| | | | Reference | | | | | |
|---|---|---|---|---|---|---|---|---|
| | Reference signs | | 4 Ag | | Example 1 | | Example 2 | |
| Glass | 1 | | 2.1 | mm | 2.1 | mm | 2.1 | mm |
| PVB | 3 | | 0.76 | mm | 0.76 | mm | 0.76 | mm |
| Si3N4 | 22a.5 | 22.5 | 15 | nm | 15 | nm | 15 | nm |
| SiZrN | 22b.5 | | 9 | nm | 9 | nm | 9 | nm |
| ZnO | 25.5 | | 13 | nm | 13 | nm | 13 | nm |
| NiCr | 26.4 | | 0.2 | nm | 0.2 | nm | 0.2 | nm |
| Ag | 21.4 | | 11 | nm | 11 | nm | 11 | nm |
| ZnO | 24.4 | | 12 | nm | 12 | nm | 12 | nm |
| ZnSnO | 23.4 | | 10 | nm | 10 | nm | 10 | nm |
| SiZrN | 22b.4 | 22.4 | 21 | nm | 21 | nm | 21 | nm |
| Si3N4 | 22a.4 | | 21 | nm | 21 | nm | 21 | nm |
| ZnO | 25.4 | | 16 | nm | 16 | nm | 16 | nm |
| NiCr | 26.3 | | 0.2 | nm | 0.2 | nm | 0.2 | nm |
| Ag | 21.3 | | 14 | nm | 14 | nm | 14 | nm |
| ZnO | 24.3 | | 14 | nm | 14 | nm | 14 | nm |
| ZnSnO | 23.3 | | 11 | nm | 11 | nm | 11 | nm |
| SiZrN | 22b.3 | 22.3 | 18 | nm | 18 | nm | 18 | nm |

| | | | | | | | |
|---|---|---|---|---|---|---|---|
| Si3N4 | 22a.3 | 17 | nm | 17 | nm | 17 | nm |
| ZnO | 25.3 | 15 | nm | 15 | nm | 15 | nm |
| NiCr | 26.2 | 0.3 | nm | 0.3 | nm | 0.3 | nm |
| Ag | 21.2 | 14 | nm | 14 | nm | 14 | nm |
| ZnO | 24.2 | 16 | nm | 16 | nm | 16 | nm |
| ZnSnO | 23.2 | 10 | nm | 10 | nm | 10 | nm |
| SiZrN | 22.2 | 33 | nm | 33 | nm | 33 | nm |
| ZnO | 25.2 | 16 | nm | 16 | nm | 16 | nm |
| NiCr | 26.1 | 0.2 | nm | 0.2 | nm | 0.2 | nm |
| Ag | 21.1 | 12 | nm | 12 | nm | 12 | nm |
| ZnO | 24.1 | 11 | nm | 11 | nm | 11 | nm |
| ZnSnO | 23.1 | 8 | nm | 8 | nm | 8 | nm |
| SiZrN | 22.1 | 12 | nm | 12 | nm | 12 | nm |
| Glass | 2 | 1.6 | mm | 1.6 | mm | 1.6 | mm |

| | | | |
|---|---|---|---|
| 31.1 | 30 | TiO2: 150 nm | Si3N4: 80 nm |

| | | |
|---|---|---|
| 31.2 | SiO2: 170 nm | SiO2: 150 nm |

TABLE 2
Examples 3 and 4

| | | | Reference | | | | | |
|---|---|---|---|---|---|---|---|---|
| | Reference signs | | 3Ag | | Example 3 | | Example 4 | |
| Glass | 1 | | 2.1 | mm | 2.1 | mm | 2.1 | mm |
| PVB | 3 | | 0.76 | mm | 0.76 | mm | 0.76 | mm |
| SiZrN | 22a.4 | 22.4 | 11 | nm | 11 | nm | 11 | nm |
| Si3N4 | 22b.4 | | 10 | nm | 10 | nm | 10 | nm |
| ZnO | 25.4 | | 10 | nm | 10 | nm | 10 | nm |
| NiCr | 26.3 | | 0.2 | nm | 0.2 | nm | 0.2 | nm |
| Ag | 21.3 | | 12 | nm | 12 | nm | 12 | nm |
| ZnO | 24.3 | | 10 | nm | 10 | nm | 10 | nm |
| ZnSnO | 23.3 | | 8 | nm | 8 | nm | 8 | nm |
| SiZrN | 22b.3 | 22.3 | 26 | nm | 26 | nm | 26 | nm |
| Si3N4 | 22a.3 | | 20 | nm | 20 | nm | 20 | nm |
| ZnO | 25.3 | | 10 | nm | 10 | nm | 10 | nm |
| NiCr | 26.2 | | 0.2 | nm | 0.2 | nm | 0.2 | nm |
| Ag | 21.2 | | 14 | nm | 14 | nm | 14 | nm |
| ZnO | 24.2 | | 10 | nm | 10 | nm | 10 | nm |
| ZnSnO | 23.2 | | 8 | nm | 8 | nm | 8 | nm |
| SiZrN | 22b.2 | 22.2 | 25 | nm | 25 | nm | 25 | nm |

| | | | | | | | |
|---|---|---|---|---|---|---|---|
| Si3N4 | 22a.2 | 20 | nm | 20 | nm | 20 | nm |
| ZnO | 25.2 | 10 | nm | 10 | nm | 10 | nm |
| NiCr | 26.1 | 0.2 | nm | 0.2 | nm | 0.2 | nm |
| Ag | 21.1 | 13 | nm | 13 | nm | 13 | nm |
| ZnO | 24.1 | 10 | nm | 10 | nm | 10 | nm |
| ZnSnO | 23.1 | 8 | nm | 8 | nm | 8 | nm |
| SiZrN | 22.1 | 11 | nm | 11 | nm | 11 | nm |
| Glass | 2 | 1.6 | mm | 1.6 | mm | 1.6 | mm |

| | | | |
|---|---|---|---|
| 31.1 | 30 | TiO2: 140 nm | Si3N4: 82 nm |

| | | |
|---|---|---|
| 31.2 | SiO2: 190 nm | SiO2: 140 nm |

TABLE 3
Comparison of transmittance values

| | Tₜₒₜ(440 nm- | T_{red}(600 nm- | Transmittance |
|---|---|---|---|
| | 700 nm)/% | 700 nm)/% | ratio T_{red}/Tₜₒₜ |
| Reference 4 Ag | 49.7 | 37.0 | 0.74 |
| Example 1 | 46.4 | 37.5 | 0.81 |
| Example 2 | 47.9 | 36.6 | 0.76 |
| Reference 3 Ag | 50.8 | 35.5 | 0.70 |
| Example 3 | 47.2 | 35.7 | 0.76 |
| Example 4 | 49.8 | 35.3 | 0.71 |

### LIST OF REFERENCE SIGNS

10 Laminated pane
1 Outer pane
2 Inner pane
3 Thermoplastic intermediate layer
4 Camera
20 Electrically conductive coating
21.1, 21.2, 21.3, 21.4 1st, 2nd, 3rd, 4th electrically conductive layer
22.1, 22.2, 22.3, 22.4, 22.5 1st, 2nd, 3rd, 4th, 5th anti-reflective layer
22a.2, 22a.3, 22a.4 1st, 2nd, 3rd low-refractive dielectric layer
22b.2, 22b.3, 22b.4 1st, 2nd, 3rd optically highly refractive index layer
23.1, 23.2, 23.3, 23.4 1st, 2nd, 3rd, 4th smoothing layer
24.1, 24.2, 24.3, 24.4 1st, 2nd, 3rd, 4th adaptation layer
25.2, 25.3, 25.4, 25.5 1st, 2nd, 3rd, 4th second adaptation layers
26.1, 26.2, 26.3, 26.4 1st, 2nd, 3rd, 4th blocker layer
30 Anti-reflection coating
31.1, 31.2, 31.3, 31.4 1st, 2nd, 3rd, 4th dielectric layer
100 Camera arrangement
I Outer-side surface of the outer pane 1 facing away from the intermediate layer 3
II Interior-side surface of the outer pane 1 facing the intermediate layer 3
III Outer-side surface of the inner pane 2 facing the intermediate layer 3
IV Interior-side surface of the inner pane 2 facing away from the intermediate layer 3

1. A laminated pane, comprising:
an outer pane and an inner pane, which are connected to one another via a thermoplastic intermediate layer,
an electrically conductive coating between the outer pane and the inner pane,
an anti-reflection coating only in a partial region of the laminated pane which is provided for a camera window,
wherein the anti-reflection coating is arranged on a surface of the inner pane facing away from the intermediate layer, and the electrically conductive coating is also arranged in the partial region.

2. The laminated pane according to claim 1, wherein the partial region with the anti-reflection coating covers only at most 70% of the surface of the inner pane facing away from the intermediate layer.

3. The laminated pane according to claim 1, wherein the anti-reflection coating is formed from alternatingly arranged dielectric layers with different refractive indices.

4. The laminated pane according to claim 3, wherein, in the anti-reflection coating, dielectric layers having a low refractive index less than or equal to 1.8, and dielectric layers with a high refractive index greater than or equal to 2.0 are arranged alternatingly.

5. The laminated pane according to claim 3, wherein the anti-reflection coating consists of two to eight alternatingly arranged dielectric layers with different refractive indices.

6. The laminated pane according to claim 4, wherein, in the anti-reflection coating, the dielectric layer or the dielectric layers with a low refractive index is or are embodied on the basis of silicon oxide or aluminum oxide, and the dielectric layer or the dielectric layers with a high refractive index is or are embodied on the basis of silicon nitride, silicon carbide, titanium oxide, a silicon-metal mixed nitride such as silicon zirconium nitride or silicon hafnium nitride.

7. The laminated pane according to claim 4, wherein, in the anti-reflection coating, a layer having a high refractive index is first arranged starting from the inner pane, and a layer having a low refractive index is arranged above it.

8. The laminated pane according to claim 4, wherein, in the anti-reflection coating, the dielectric layers each have a geometric layer thickness between 30 nm and 500 nm.

9. The laminated pane according to claim 1, wherein the electrically conductive coating is an IR-reflective and/or heatable coating.

10. The laminated pane according to claim 1, wherein the electrically conductive coating comprises at least two electrically conductive layers, each of which is arranged between two dielectric layers or layer sequences.

11. The laminated pane according to claim 10, wherein the electrically conductive layers are formed based on silver and each have a layer thickness of 3 nm to 20 nm.

12. The laminated pane according to claim 1, wherein the anti-reflection coating and/or the electrically conductive coating is/are applied via physical vapor deposition.

13. The laminated pane according to claim 1, wherein a transmittance ratio, calculated as a ratio of the transmittance in the spectral range of 600 nm to 700 nm to the transmittance in the spectral range of 440 nm to 700 nm, in the partial region with the anti-reflection coating is at least 0.70.

14. A camera arrangement, having a camera and a laminated pane according to claim 1, wherein the camera is directed onto the partial region with the anti-reflection coating and receives light beams which fall through the laminated pane.

15. A method comprising providing a laminated pane according to claim 1 as a front pane with a camera window in a water, land, and air transportation vehicle.

16. The laminated pane according to claim 2, wherein the partial region with the anti-reflection coating covers only at most 40% of the surface of the inner pane facing away from the intermediate layer.

17. The laminated pane according to claim 4, wherein the dielectric layers have a low refractive index less than or equal to 1.7, and the dielectric layers have a high refractive index greater than or equal to 2.1.

18. The laminated pane according to claim 5, wherein the anti-reflection coating consists of two to six alternatingly arranged dielectric layers with different refractive indices.

19. The laminated pane according to claim 8, wherein the geometric layer thickness is between 50 nm and 300 nm.

20. The laminated pane according to claim 10, wherein the electrically conductive coating comprises at least three electrically conductive layers.
